(19) United States
(12) Patent Application Publication
(10) Pub. No.: US 2011/0287846 A1
(43) Pub. Date: Nov. 24, 2011

(54) DEVICE FOR TRANSMITTING TORQUES WHILE DAMPING VIBRATIONS, AND BUSHING ARRANGEMENT FOR THE SAME, AND METHOD FOR PRODUCING SUCH A DEVICE

(75) Inventors: Armin Drechsler, Ampfing (DE); Roland Liessel, Waldkraiburg (DE); Jan Hoffmann, Waldkraiburg (DE)

(73) Assignee: SGF SUEDDEUTSCHE GELENKSCHEIBENFABRIK GMBH & CO KG, Waldkraiburg (DE)

(21) Appl. No.: 13/139,651

(22) PCT Filed: Dec. 4, 2009
(86) PCT No.: PCT/EP2009/008680

§ 371 Date: Aug. 3, 2011

(30) Foreign Application Priority Data
Dec. 15, 2008 (DE) 10 2008 062 305.9

(51) Int. Cl. B62D 1/19; B23P 17/00; F16D 3/04; F16D 3/06; F16D 3/12

(52) U.S. Cl. 464/161; 267/140.5; 29/428

(57) ABSTRACT

The invention relates to a device (10) for transmitting torques while damping vibrations, particularly in a steering spindle arrangement, said device comprising a spindle connection part (12) for coupling to an end segment of a steering spindle, a damping bushing arrangement (16) that can be coupled to the spindle connection part (12), and a fork part (18) that can be coupled to the bushing arrangement (16) for transmitting torque. In this device, provision is made for the bushing arrangement (16) to be disposed between the spindle connection part (12) and the fork part (18), the bushing arrangement (16) having a first damping layer (60) made of elastomeric material for damping bending loads, and said bushing arrangement (16) having a second damping layer (62) made of elastomeric material for damping torsional loads.

### TECHNICAL FIELD

The present invention relates to a device for transmitting torques while damping vibrations, particularly in a steering spindle arrangement.

### BACKGROUND OF RELATED ART A device of this kind is known, for example, from document DE 10 2004 051 566 B4. In the device indicated therein, a steering spindle segment is connected, via a flexible bushing arrangement and a joint disc, to a fork part of the steering spindle arrangement. The said fork part is a component part of a cardanic connection via which the steering moment exerted by a steering wheel is transmitted onwards. The flexible bushing arrangement serves to damp bending loads, whereas the joint disc serves to transmit torques in a damped manner.

Although the device indicated in the prior art, which is made of the components described above, has proved successful in practice, it has turned out that disadvantages arise as a result of its being constructed from a large number of individual components.

One object of the present invention is therefore to make available a device for transmitting torques while damping vibrations, which is capable of replacing the arrangement known from the prior art while having a compact type of construction and improved damping behaviour.

### SUMMARY

This object is achieved by means of a device for transmitting torques while damping vibrations, particularly in a steering spindle arrangement, wherein said device comprises: a spindle connection part for coupling to an end segment of a steering spindle, a damping bushing arrangement that can be coupled to the spindle connection part, and a fork part that can be coupled to the bushing arrangement for transmitting torque, wherein the bushing arrangement is disposed between the spindle connection part and the fork part, wherein the bushing arrangement has a first damping layer made of elastomeric material for damping bending loads, and wherein the bushing arrangement has a second damping layer made of elastomeric material for damping torsional loads.

In the device according to the invention, otherwise than in the case of the prior art described above, both the function of damping bending moments and also the function of damping torque vibrations are integrated, together with the fork part for cardanic connection, in one component part, resulting, overall, in a considerably simplified construction compared with the multipart design from the prior art. The functions of the individual components used in the prior art, namely of the bushing arrangement, of the joint disc, of centring via a centring bolt and of the fork part, are taken over, separately from one another, by corresponding components of the compact device according to the invention. Thus, the damping of bending loads takes place via the first damping layer, which is specially matched to this loading eventuality, while the damping of torsional loads takes place via the second damping layer.

According to a preferred form of embodiment of the invention, provision is made for the bushing arrangement to have a plurality of annular bushing parts which are concentric with one another and which are connected to one another in pairs via the first and second damping layers. The individual bushing parts may be closed rings made of solid material or—for the purpose of saving weight—may also be annular bodies which are provided with clearances in the material and radially extending webs.

In particular, provision is made, in one variant of embodiment of the invention, for the bushing arrangement to have a first, internally located bushing part which is of tubular construction and is received concentrically in a second, central bushing part which surrounds it, the first, internally located bushing part being connected to the second, central bushing part in a force-transmitting manner via the first damping layer.

Provision may also be made, according to the invention, for spacers which project radially outwards to be provided, in a manner distributed at regular angular intervals, on the outer peripheral face of the first, internally located bushing part in its axial end region, and for spacers which project radially inwards to be provided on the inner peripheral face of the second, central bushing part, at the opposite end of said face. Spacers of this kind delimit the maximum relative deflection between the first, internally located bushing part and the second, central bushing part when subjected to bending stress.

One further development of the invention makes provision for the second, central bushing part to be received concentrically in a third, externally located bushing part, the second, central bushing part being connected, in a force-transmitting and torque-transmitting manner, to the third, externally located bushing part via the second damping layer.

As regards the dimensioning of the damping layers, provision may be made for the first damping layer to be constructed with a greater axial extension than the second damping layer, while the second damping layer is constructed with a greater radial extension than the first damping layer. In this connection, provision may also be made for the second damping layer to be produced from an elastomeric material of a different kind, in particular a more pliant elastomeric material, than the first damping layer. By this means, it is possible for the first damping layer to be matched, in particular, to the eventuality of a bending load, so that it has relatively high stiffness against bending or flexure because of its axial length and its relatively low radial thickness, whereas the second damping layer, with its relatively small axial extension and accordingly greater radial extension, and optionally because of the use of a more pliant elastomeric material, particularly copes with the damping of torsional vibrations.

For centring purposes, provision may be made for the third, externally located bushing part for transmitting torque to be received in a force-locking or form-locking manner in a receiving pot on the fork part. Under these circumstances, the centring bolt may be pressed fixedly into the fork part and thus centres the bushing arrangement, relative to said fork part, via the first, internally located bushing part. The spindle connection part and, with it, the attached steering spindle are thus also positioned, in particular centred, relative to the fork part via the bushing arrangement.

One further development of the invention makes provision for the third, externally located bushing part for transmitting torque to be received in a force-locking or form-locking manner in a receiving pot on the fork part. For this purpose, there are preferably provided, on the externally located bushing part, radially projecting engaging formations which engage in a form-locking manner in corresponding clearances in the receiving pot on the fork part for the benefit of reliable torque transmission. All that therefore happens, in the context of damping torsional vibrations, is a torsional relative movement between the receiving pot on the fork part, which pot is coupled in a form-locking manner to the third, externally located bushing part, and the central bushing part via a deformation of the second damping layer made of elastomeric material.

For the further transmission of torque to the bushing arrangement, provision may be made, according to the invention, for the second, central bushing part to be connected to the spindle connection part, and preferably press-fitted to the latter, in a torque-transmitting manner. The torque transmitted by the steering spindle to the spindle connection part coupled to the latter in a rotation-proof manner is thus transmitted directly to the second, central bushing part. The first, internally located bushing part is therefore uncoupled from the torque transmission and serves solely to transmit and damp bending moments between the spindle connection part and the form part with the inclusion of the centring bolt and the first damping layer made of elastomeric material.

One further development of the invention makes provision for stops for limiting the relative movement between the spindle connection part and the fork part to be provided between said spindle connection part and said fork part in the axial direction or/and in the peripheral direction. In view of the fact that, in the eventuality of application in a longitudinal spindle arrangement, only low torques and bending moments are transmitted, and the damping layers are designed accordingly, suitable stop means serve for safeguarding against the destruction of the damping layers of the device according to the invention.

Provision may also be made, according to the invention, for the spindle connection part to have at least one first stop tongue which protrudes radially outwards and which is received in a corresponding stop clearance in the fork part with radial or/and axial play. In this connection, it is possible for the spindle connection part to have at least one second stop tongue which protrudes radially outwards and which can be brought into interaction with an axial stop on the fork part. In one specific variant of embodiment of the invention, this can happen through the fact that the axial stop on the fork part can be produced by incising the receiving pot in the peripheral direction in certain sections and deforming an edge region of the receiving pot that lies in the region of the incision, in such a way that the deformed edge region of the receiving pot engages over the second stop tongue on the fork part.

The invention also relates to a bushing arrangement for a device of the kind described above; wherein said bushing arrangement has a plurality of annular bushing parts which are concentric with one another and which are connected to one another in pairs via the first and second damping layers; wherein the bushing arrangement has a first, internally located bushing part which is of tubular construction and is received concentrically in a second, central bushing part which surrounds it; wherein the first, internally located bushing part is connected to the second, central bushing part in a force-transmitting and torque-transmitting manner via the first damping layer; and wherein the second, central bushing part is received concentrically in a third, externally located bushing part, the second, central bushing part being connected, in a force-transmitting and torque-transmitting manner, to the third, externally located bushing part via the second damping layer.

According to the invention, provision may be made, in this connection, for spacers which project radially outwards to be provided, in a manner distributed at regular angular intervals, on the outer peripheral face of the first, internally located bushing part in its axial end region, and for spacers which project radially inwards to be provided on the inner peripheral face of the second, central bushing part at the opposite end of said face. Under these circumstances, provision may be made, as has already been described above, for the first damping layer to be constructed with a greater axial extension than the second damping layer, said second damping layer being constructed with a greater radial extension than the first damping layer, and said second damping layer preferably being produced from an elastomeric material of a different kind, in particular a more pliant elastomeric material, than the first damping layer. In particular, it is possible for the first bushing part, the second bushing part and the third bushing part to be manufactured, in an initial state, as a cohering component part made of plastic material and to be connected to one another via preset breaking points which can be broken open, prior to the fitting of the damping layers, when the first bushing part, second bushing part and third bushing part are positioned in their intended position in relation to one another.

The invention also relates to a method of producing a device of the kind described above using a corresponding bushing arrangement, which method is characterised by the following steps:
the production of a blank for the bushing arrangement from a first, a second and a third bushing part, which cohere via preset breaking points;
the positioning of the first, second and third bushing parts in their intended position in relation to one another while breaking open the preset breaking points;
the fitting of the damping layers made of elastomeric material between the first and second, and also the second and third bushing parts; and
the connecting of the bushing arrangement to the spindle connection part and also to the fork part.

The individual manufacturing steps will be explained again in detail in the description of the drawings that follows.

### BRIEF DESCRIPTION OF THE DRAWINGS

The invention will be explained below in an exemplified manner with the aid of the accompanying drawings, in which:

FIG. 1 represents a perspective exploded view of the device according to the invention;

FIG. 2 represents a sectional view, including the axis, of a blank for the bushing arrangement according to the invention;

FIG. 3 represents a perspective view of the component part from FIG. 2;

FIG. 4 represents a view corresponding to FIG. 2, after the preset breaking points have been broken open;

FIG. 5 represents a perspective view of the component part according to FIG. 4;

FIG. 6 represents a sectional view, including the axis, of the bushing arrangement after the damping layers have been fitted;

FIG. 7 represents a perspective view of the bushing arrangement according to FIG. 6;

FIG. 8 represents a sectional view, including the axis, of the bushing arrangement after the spindle connection part has been pressed on;

FIG. 9 represents a perspective view of the component part according to FIG. 8;

FIG. 10 represents a sectional view, including the axis, of the bushing arrangement with the spindle connection part, after insertion in the fork part;

FIG. 11 represents a perspective view of the device according to FIG. 10;

FIG. 12 represents a sectional view, including the axis, of the device according to the invention, in the final state prior to installation in a steering spindle arrangement; and

FIG. 13 represents a perspective view of the device according to FIG. 12.

### DETAILED DESCRIPTION

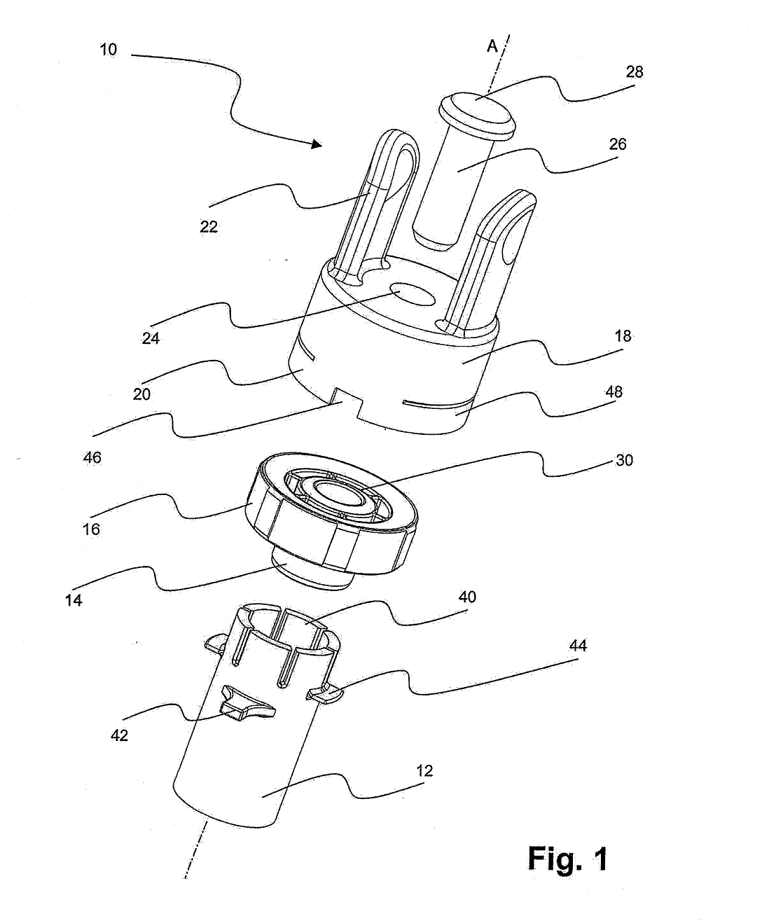

In FIG. 1, the device according to the invention is shown in a perspective exploded view and is designated generally by 10. The said device comprises a spindle connection part 12 which is constructed for coupling to an end segment of a steering spindle. A bushing arrangement 16, which is constructed for damping torsional vibrations as well as bending vibrations, can be coupled to the spindle connection part 12 via a coupling peg 14.

The bushing arrangement 16 can be coupled to a fork part 18 which has a receiving pot 20 for receiving said bushing arrangement. Said fork part 18 has projecting fork arms 22 that can be used as part of a universal joint which is known per se and of which no further details are shown.

A centring bolt 26 can be pressed into an aperture 24 until its head 28 rests against that bottom face of the joint part 18 which contains said aperture. The centring bolt 26 extends into a first, internally located bushing part 30 of the bushing arrangement 16 and is received in said bushing part with slight play after the manner of a sliding bearing.

It will also be seen in FIG. 1 that the upper axial end segment of the spindle connection part 12 is of slotted design, it being possible to press-fit the slotted webs of material 40 to the peg 14. In addition, the spindle connection part 12 has first radially protruding stop tongues 42 and second radially protruding stop tongues 44. Said first radially protruding stop tongues 42 are received in corresponding clearances 46 in the receiving pot 20 on the joint part 18 with radial and axial play. The second stop tongues 44 serve as an axial stop and, after deformation (crimping), are retained axially by segments 48 of the receiving pot 18 which are partially uncoupled by slots.

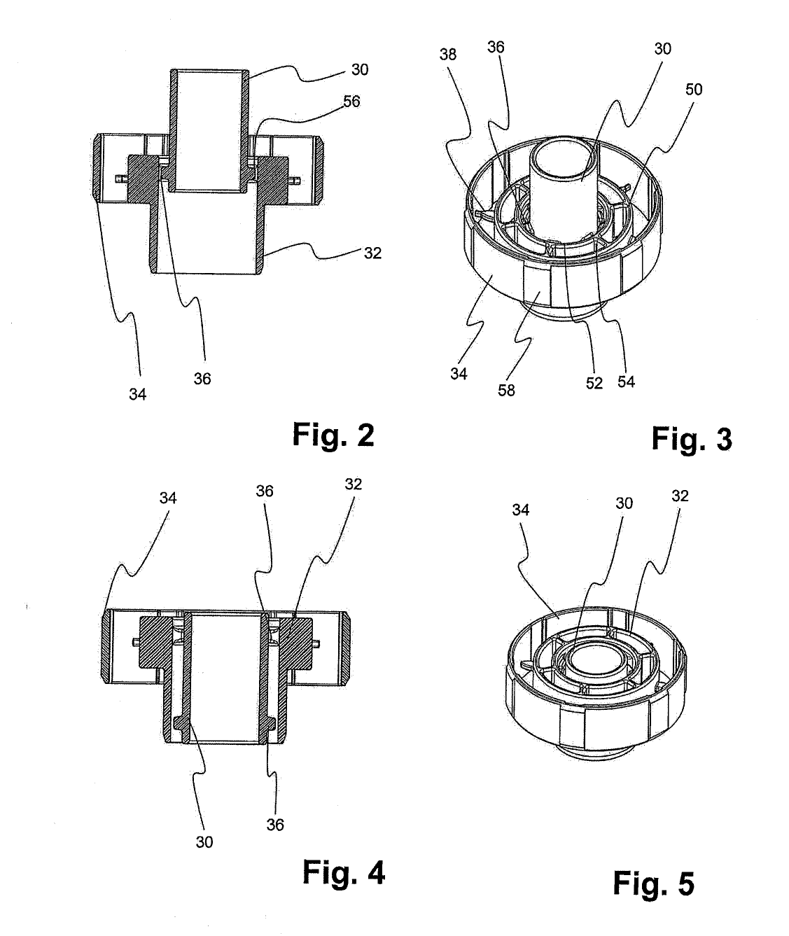

In particular, the construction of the individual components of the device 10 according to the invention, and also the relative disposition of the said components in relation to one another and their interaction, will be gone into in detail with reference to FIGS. 2 to 13.

The individual parts will be described below with regard to their construction and also with regard to fitting in relation to the overall arrangement of the device according to the invention.

FIG. 2 shows a blank for the bushing arrangement 16 according to the invention, in a sectional view, including the axis, while FIG. 3 shows the said blank in a perspective representation. The said blank is composed of the radially inner bushing part 30, a central bushing part 32 and an outer bushing part 34. The three bushing parts 30, 32 and 34 are all produced from the same material, preferably injection-moulded from plastic, and are connected to one another in pairs via connecting webs 36, 38 when in the initial state shown in FIGS. 2 and 3. The connecting webs 36, 38 are formed during the injection-moulding process. They serve as preset breaking points between the individual bushing parts 30, 32, 34.

It will also be seen in FIG. 3 that the second, central bushing part 32 has, per se, two rings 50 and 52 which are connected to one another via radially extending break-proof connecting webs 54 disposed at regular angular intervals. It will further be seen, particularly in the sectional representation according to FIG. 2 but also in FIG. 3, that there are provided in each case, both on the internally located bushing part 30 and also on the central bushing part 32, spacers 56 which guarantee a predetermined minimum interval between these two components, even in the eventuality of loading.

It will be seen in FIG. 3, finally, that radial projections 58, the function of which will be gone into again in detail, are provided on the outer periphery of the bushing part 34 which is located on the outside radially.

In the course of the process for manufacturing the device according to the invention, the blank according to FIGS. 2 and 3, which is produced in one piece, is placed in a suitable tool prior to the fitting of damping layers. When the tool is closed, the individual bushing parts are pressed together axially in relation to one another, under which circumstances the preset breaking points 36 and 38 break open. In other words, starting from the state according to FIGS. 2 and 3, the blank is compressed in a telescopic manner, with the breaking-open of the preset breaking points, into the state according to FIGS. 4 and 5. It will be seen in FIG. 5 that the internally located bushing part 30 has now been pushed into the central bushing part 32, so that the spacers 36 on the inner and central bushing parts 30 and 32 respectively, are offset in angular terms in relation to one another in each case, but are disposed, axially at the ends, in the intervening space between the internally located bushing part 30 and the central bushing part 32. In addition, it can be seen that the central bushing part 32 has also been displaced in the axial direction, relative to the outer bushing part 34. FIG. 5 shows this arrangement in a perspective representation.

In the state shown in FIGS. 4 and 5, elastomeric layers are now fitted between the bushing parts. In particular, a first elastomeric damping layer 60, which extends over a relatively large axial length, namely over the entire intervening space between the internally located bushing part 30 and the central bushing part 32, is fitted between said internally located bushing part and said central bushing part 32. A second elastomeric damping layer 62 is injection-moulded in between the central bushing part 32 and the externally located bushing part 34. Said damping layer is constructed with a shorter axial extension than the damping layer 60, but is considerably wider in the radial direction. These layers and their differing radial extensions can also be seen in the perspective representation according to FIG. 7. It can also be seen, in FIG. 7, that no elastomeric mass has been injection-moulded in between the two annular bodies 50 and 52 of the central bushing part.

The two elastomeric masses for the damping layers 60 and 62 may differ from one another in their nature, particularly in their damping capacity (hardness).

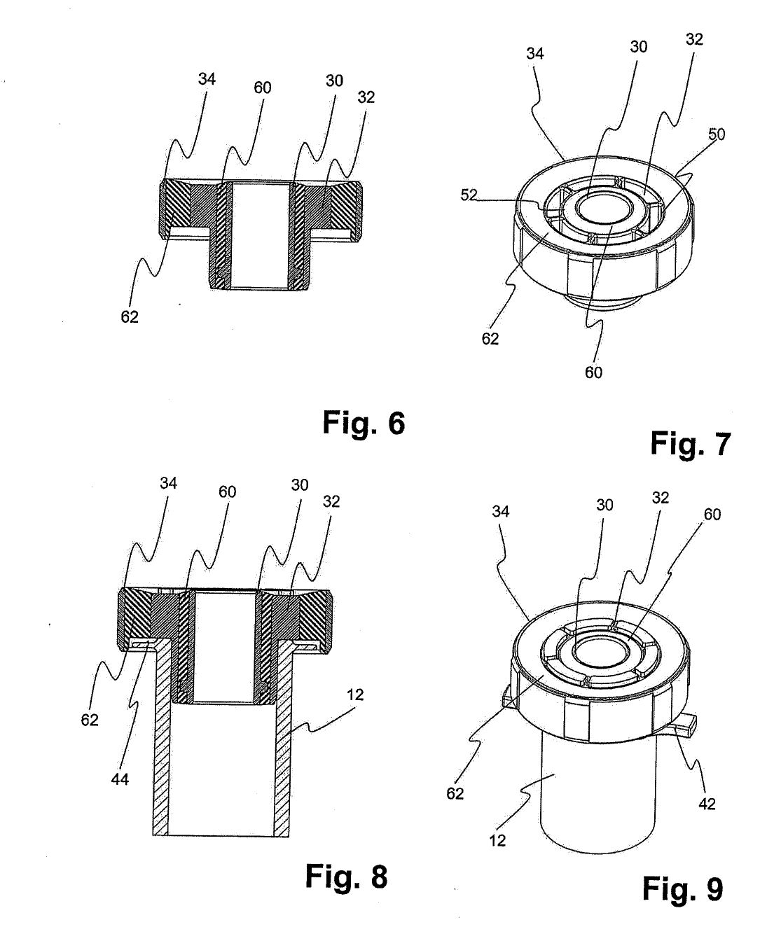

In the views shown in FIGS. 8 and 9, as distinct from the views according to FIGS. 6 and 7, the spindle connection part 12 has been pressed onto the central bushing part 32, so that torques can be transmitted to the latter by said spindle connection part 12. It can also be seen that the spindle connection part 12 has, at its axial end, the stop tongues 44 which are disposed inside the bushing arrangement, as well as the stop tongues 42 which jut out beyond said bushing arrangement in the radial direction.

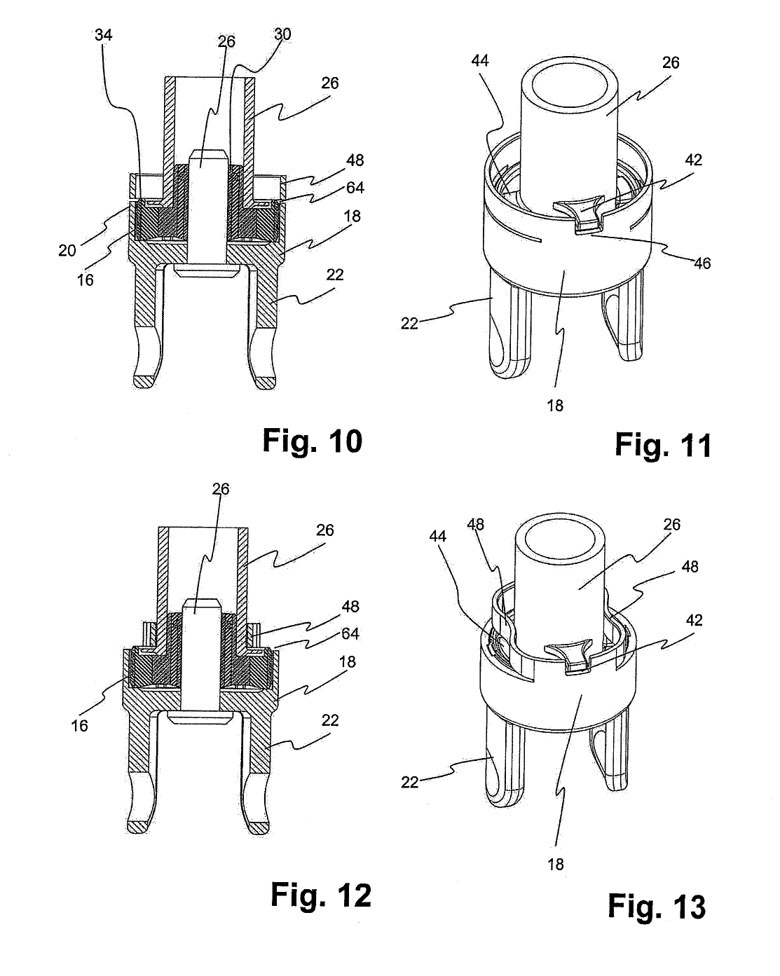

In FIGS. 10 and 11, it can be seen that the arrangement according to FIGS. 8 and 9 is slipped into the joint part 18, the centring bolt 26 engaging in the internally located bushing part 30. It can also be seen, in FIG. 11, that the stop tongues 42 engage in the associated receiving apertures 46 in each case. The externally located bushing part 34 is received in a form-locking manner in the receiving pot 20 on the joint part 18.

The final state of the device according to the invention, prior to installation in the steering spindle arrangement, can be seen in FIGS. 12 and 13. The only difference from FIGS. 10 and 11 consists in the fact that the two segments 48, which are cut free by means of the slots 64, have been crimped radially inwards in a permanent manner, so that they are located above the stop tongues 44. The bushing arrangement 16 is thereby axially secured together with the spindle connection part 12.

The arrangement is thus connected in a torque-transmitting manner, via the spindle connection part, to one end of a longitudinal spindle, for example by press-fitting or screwing. The fork part 18 is coupled to a universal joint spider of a cardanic arrangement.

Overall, a large number of advantages arise for the device according to the invention. The subassembly according to the prior art initially described, which is of relatively large build, is replaced, by means of the device according to the invention, by a substantially more compact arrangement designed as a component part, which saves on structural space, while at the same no disadvantages are suffered in terms of functioning. Instead, this arrangement guarantees that the functions of supporting a bending moment and of torsional support are decoupled from one another. Because the bushing part is manufactured from plastic, the MEGUM™-bonding which is necessary in the case of a metal development is dispensed with, which likewise makes production easier. Because the centring bolt 26 is received in the inner bushing part 30 in the manner of a sliding bearing, said centring bolt 26 exerts only a bending load, and does not transmit torsional forces.

The damping layers 60 and 62 made of elastomer can be constructed with stronger or weaker elasticity, as required. Also, production of the bushing arrangement is made considerably easier by the fact that the blank shown in FIGS. 2 and 3 is produced in one piece.

Only torques have to be transmitted via the damping layer 62. If predetermined limiting moments are exceeded, the stop tongues 42 cooperate with the associated clearances 46, so that direct transmission takes place (as a result of form-locking) as soon as the limiting moments are exceeded.

In the case of greater bending moments, the spacers 36 act as stops.

1. Device (10) for transmitting torques while damping vibrations, particularly in a steering spindle arrangement, said device comprising:
a spindle connection part (12) for coupling to an end segment of a steering spindle;
a damping bushing arrangement (16) that can be coupled to the spindle connection part (12); and
a fork part (18) that can be coupled to the bushing arrangement (16) for transmitting torque;
wherein the bushing arrangement (16) is disposed between the spindle connection part (12) and the fork part (18); wherein the bushing arrangement (16) has a first damping layer (60) made of elastomeric material for damping bending loads; and wherein the bushing arrangement (16) has a second damping layer (62) made of elastomeric material for damping torsional loads.

2. Device (10) according to claim 1, characterised in that the bushing arrangement (16) has a plurality of annular bushing parts (30, 32, 34) which are concentric with one another and which are connected to one another in pairs via the first and second damping layers (60, 62).

3. Device (10) according to claim 2,
characterised in that the bushing arrangement (16) has a first, internally located bushing part (30) which is of tubular construction and is received concentrically in a second, central bushing part (32) which surrounds it, the first, internally located bushing part (30) being connected to the second, central bushing part (32) in a force-transmitting manner via the first damping layer (60).

4. Device (10) according to claim 3,
characterised in that spacers (36) which project radially outwards are provided, in a manner distributed at regular angular intervals, on the outer peripheral face of the first, internally located bushing part (30) in its axial end region, and that spacers (36) which project radially inwards are provided on the inner peripheral face of the second, central bushing part (32) at the opposite end of said face.

5. Device (10) according to one of claims 2 to 4,
characterised in that the second, central bushing part (32) is received concentrically in a third, externally located bushing part (34), said second, central bushing part (32) being connected, in a force-transmitting and torque-transmitting manner, to the third, externally located bushing part (34) via the second damping layer (62).

6. Device (10) according to claims 3 and 5,
characterised in that the first damping layer (60) is constructed with a greater axial extension than the second damping layer (62), while the second damping layer (62) is constructed with a greater radial extension than the first damping layer (60).

7. Device (10) according to claim 6,
characterised in that the second damping layer (62) is produced from an elastomeric material of a different kind, in particular a more pliant elastomeric material, than the first damping layer (60).

8. Device (10) according to one of claims 3 to 7,
characterised in that the first, internally located bushing part (30) is coupled to the fork part (18) via a centring bolt (26), said first, internally located bushing part (30) receiving the centring bolt (26) for positioning said bushing part (30), relative to the fork part (18), substantially without play.

9. Device (10) according to one of claims 5 to 8,
characterised in that the third, externally located bushing part (34) for transmitting torque is received in a force-locking or form-locking manner in a receiving pot (20) on the fork part (18).

10. Device (10) according to one of claims 3 to 9,
characterised in that the second, central bushing part (32) is connected to the spindle connection part (12), and preferably press-fitted to the latter, in a torque-transmitting manner.

11. Device (10) according to one of the preceding claims,
characterised in that stops (42) for limiting the relative movement between the spindle connection part (12) and the fork part (18) are provided between said spindle connection part (12) and said fork part (18) in the axial direction or/and in the peripheral direction.

12. Device (10) according to claim 11,
characterised in that the spindle connection part (12) has at least one first stop tongue (42) which protrudes radially outwards and which is received in a corresponding stop clearance in the fork part (18) with radial or/and axial play.

13. Device (10) according to claim 11 or 12,
characterised in that the spindle connection part (12) has at least one second stop tongue (44) which protrudes radially outwards and which can be brought into interaction with an axial stop on the fork part (18).

14. Device (10) according to claims 9 and 12,
characterised in that the axial stop on the fork part (18) can be produced by incising the receiving pot (20) in the peripheral direction in certain sections and deforming an edge region of the receiving pot (20) that lies in the region of the incision, in such a way that the deformed edge region of the receiving pot (20) engages over the second stop tongue on the fork part (18).

15. Bushing arrangement (16) for a device (10) according to one of the preceding claims; wherein said bushing arrangement (16) has a plurality of annular bushing parts (30, 32, 34) which are concentric with one another and which are connected to one another in pairs via the first and second damping layers (60, 62); wherein the bushing arrangement (16) has a first, internally located bushing part (30) which is of tubular construction and is received concentrically in a second, central bushing part (32) which surrounds it; wherein the first, internally located bushing part (30) is connected to the second, central bushing part (32) in a force-transmitting manner via the first damping layer (60); and wherein the second, central bushing part (32) is received concentrically in a third, externally located bushing part (34), said second, central bushing part (32) being connected, in a force-transmitting and torque-transmitting manner, to the third, externally located bushing part (34) via the second damping layer (62).

16. Bushing arrangement (16) according to claim 15,
characterised in that spacers which project radially outwards are provided, in a manner distributed at regular angular intervals, on the outer peripheral face of the first, internally located bushing part (30) in its axial end region, and that spacers which project radially inwards are provided on the inner peripheral face of the second, central bushing part (32) at the opposite axial end of said face.

17. Bushing arrangement (16) according to claim 15 or 16,
characterised in that the first damping layer (60) is constructed with a greater axial extension than the second damping layer (62), while the second damping layer (62) is constructed with a greater radial extension than the first damping layer (60) and the second damping layer (62) is preferably produced from an elastomeric material of a different kind, in particular a more pliant elastomeric material, than the first damping layer (60).

18. Bushing arrangement (16) according to one of claims 15 to 17,
characterised in that the first bushing part (30), the second bushing part (32) and the third bushing part (34) are manufactured, in an initial state, as a cohering component part made of plastic material and are connected to one another via preset breaking points which can be broken open, prior to the fitting of the damping layers (60, 62), when the first bushing part (30), second bushing part (32) and third bushing part (34) are positioned in their intended position in relation to one another.

19. Method of producing a device (10) according to one of claims 1 to 14, using a bushing arrangement (16) according to one of claims 15 to 18, which method is characterised by the following steps:
the production of a blank for the bushing arrangement (16) from a first, a second and a third bushing part (30, 32, 34), which cohere via preset breaking points;
the positioning of the first, second and third bushing parts (30, 32, 34) in their intended position in relation to one another while breaking open the preset breaking points;
the fitting of the damping layers (60, 62) made of elastomeric material between the first and second, and also between the second and third bushing parts (30, 32, 34); and
the connecting of the bushing arrangement (16) to the spindle connection part (12) and also to the fork part (18).
